(19) United States
(12) Patent Application Publication
(10) Pub. No.: US 2025/0137505 A1
(43) Pub. Date: May 1, 2025

(54) Electromechanical Brake and Locking Device for Same

(71) Applicant: Robert Bosch GmbH, Stuttgart (DE)

(72) Inventors: Xiaokun Zhang, Suzhou (CN); Fei Yu, Suzhou (CN)

(21) Appl. No.: 18/925,570

(22) Filed: Oct. 24, 2024

(30) Foreign Application Priority Data
Oct. 26, 2023 (CN) 2023 1140 8448.2

(51) Int. Cl. F16D 65/18; F16D 121/24; F16D 125/40; F16D 127/06

(52) U.S. Cl. CPC F16D 65/18; F16D 2121/24; F16D 2125/40; F16D 2127/06

(57) ABSTRACT

An electromechanical brake and a locking device for the same are disclosed. The locking device includes (i) a bracket, (ii) a rotating lever that has an operating end for being interlocked with a ratchet of the electromechanical brake, the rotating lever being connected to the bracket through a rotating shaft, such that the rotating lever is capable of rotating between an idle position and a working position with the rotating shaft as a rotation axis, (iii) an electromagnet, the electromagnet acting on an action end of the rotating lever, thereby causing the rotating lever to rotate from the idle position to the working position, and (iv) a reset member, the reset member causing the rotating lever to return to the idle position from the working position. The locking device is configured such that a movement distance of the operating end of the rotating lever is more than 3 times a movement distance of the action end during movement of the rotating lever from the idle position to the working position. Thus, the electromechanical brake occupies a smaller space and is more compact.

This application claims priority under 35 U.S.C. § 119 to patent application no. CN 2023 1140 8448.2, filed on Oct. 26, 2023 in China, the disclosure of which is incorporated herein by reference in its entirety.

The present disclosure relates to the field of vehicle brake devices, and more particularly relates to an electromechanical brake and a locking device for the same.

### BACKGROUND

An electromechanical brake is a device that utilizes an electric motor to actuate the brake caliper for braking. Compared to conventional hydraulic brake systems, it has advantages such as rapid response, simple structure, and ease of maintenance. With the development of vehicle electrification and intelligence, electromechanical brakes have become a development trend of braking systems thanks to their integrability with electric control systems. Because the electromechanical brake is disposed inside a vehicle hub, it is a challenge in the design of the electromechanical brake to balance the compactness and functionality.

In a conventional hydraulic brake system, hydraulic pressure in a brake cylinder is maintained by a hand brake or a foot brake, thereby achieving parking brake. For the electromechanical brake, in order to achieve the parking brake function, a parking locking device is commonly configured, for example, a pin driven by an electromagnetic actuator is used to interfere with a transmission mechanism to lock the brake, however, such systems need to keep the electromagnetic actuator powered on when a vehicle is parked, which may lead to brake parking failures when the electromagnetic actuator breaks down.

### SUMMARY

An object of the present application is to solve or at least alleviate problems existing in the prior art.

In one aspect, a locking device for an electromechanical brake is provided, comprising:
a bracket;
a rotating lever, the rotating lever comprising an operating end for being interlocked with a ratchet of the electromechanical brake, the rotating lever being connected to the bracket through a rotating shaft, such that the rotating lever is capable of rotating between an idle position and a working position with the rotating shaft as a rotation axis;
an electromagnet, the electromagnet acting on an action end of the rotating lever, thereby causing the rotating lever to rotate from the idle position to the working position;
a reset member, the reset member causing the rotating lever to return to the idle position from the working position;
wherein the locking device is configured such that a movement distance c of the operating end of the rotating lever is more than 3 times a movement distance d of the action end during movement of the rotating lever from the idle position to the working position, and optionally, the movement distance c of the operating end of the rotating lever is more than 5 times the movement distance d of the action end.

Optionally, in an example of the locking device, the operating end is located on a first side of the rotating shaft, the rotating lever further comprises a counterweight part located on a second side of the rotating shaft that is opposite to the first side, such that a center of gravity of the rotating lever is near the rotating shaft.

Optionally, in an example of the locking device, a distance from the center of gravity of the rotating lever to the rotating shaft is less than 1 cm.

Optionally, in an example of the locking device, the counterweight part is disposed on the action end, or the rotating lever comprises a first arm, a second arm, and a third arm that extend from a shaft hole along three directions, and end parts of the first arm, the second arm, and the third arm are configured as the operating end, the action end, and the counterweight part, respectively.

Optionally, in an example of the locking device, the operating end, the action end and/or the counterweight part have extension parts extending axially.

Optionally, in an example of the locking device, a maximum distance of the operating end to the rotating shaft is more than 3 times a maximum distance from the counterweight part to the rotating shaft.

Optionally, in an example of the locking device, a maximum distance of the operating end to the rotating shaft is more than 5 times a maximum distance from the counterweight part to the rotating shaft.

Optionally, in an example of the locking device, the bracket is a separate locking device housing, the rotating lever is connected to the locking device housing through the rotating shaft, the locking device housing comprises a first cavity for containing the electromagnet and a second cavity for containing the rotating shaft, the rotating lever and the reset member.

Optionally, in an example of the locking device, the first cavity is configured to be matched with the electromagnet in shape, the first cavity and the second cavity are spaced apart by an intermediate wall, and the intermediate wall has a bore that allows an execution end of the electromagnet to pass through.

Optionally, in an example of the locking device, the second cavity comprises opposing walls, and the rotating shaft is connected to mounting holes of the opposing walls.

Optionally, in an example of the locking device, the rotating lever is arranged on the rotating shaft in a sleeving mode, and washers are disposed between the rotating lever and the opposing walls to limit the rotating lever axially.

Optionally, in an example of the locking device, the reset member is a folding spring and is mounted on a pin extending from the opposing walls.

Optionally, in an example of the locking device, the folding spring comprises a first end connected to a first pin, a bending part bypassing the second pin, and a second end connected to the rotating lever.

Optionally, in an example of the locking device, the locking device further comprises banking pins extending from the opposing walls, and the banking pins are configured to limit the rotating lever when the rotating lever returns to the idle position from the working position.

Optionally, in an example of the locking device, the banking pins are wrapped with cushion collars.

Optionally, in an example of the locking device, the bracket forms an end cap of a main module of the electromechanical brake, the end cap has an additional containing cavity for containing the electromagnet, and the electromagnet is disposed in the additional containing cavity.

Optionally, in an example of the locking device, one end of the rotating shaft of the rotating lever is disposed in a bore of the end cap, the rotating lever is rotatably fixed to the rotating shaft, the reset member is a torsion spring disposed on the rotating shaft, a first end of the torsion spring abuts against a hook part of the rotating lever, and a second end of the torsion spring is fixed.

In another aspect, an electromechanical brake is further provided, comprising:
a brake motor;
a spindle coupled with the brake motor, the spindle being driven by the brake motor to rotate along a first direction to drive a brake module to perform a brake operation, wherein a ratchet is fixedly disposed on the spindle; and
a locking device according to various examples, wherein the operating end is separated from the ratchet when the rotating lever of the locking device is in the idle position, and the operating end is interlocked with the ratchet when the rotating lever of the locking device is in the working position;
wherein the ratchet and the operating end of the rotating lever are disposed such that when in the working position, the operating end interacts with the ratchet to prevent the ratchet from rotating in a second direction opposite to the first direction and to prevent the rotating lever from rotating towards the idle position.

Optionally, in an example of the electromechanical brake, the spindle comprises a front end and a rear end that are opposite, the front end of the spindle is coupled with the brake module through a ball screw nut mechanism, the ratchet is fixedly mounted on the rear end of the spindle, and a worm gear is fixedly arranged in a middle section between the front end and the rear end of the spindle.

Optionally, in an example of the electromechanical brake, an output shaft of the brake motor is configured as a worm meshed with the worm gear on the spindle.

Optionally, in an example of the electromechanical brake, the electromechanical brake comprises: a brake motor, a main module, a brake module and an electronic control unit, the main module comprises a main housing and an end cap, the spindle, the ball screw nut mechanism, the ratchet, the worm gear and the locking device are contained between the main housing and the end cap, a first end of the main housing is connected to the brake module, a second end of the main housing that is opposite to the first end is closed by the first end, and the brake motor and the electronic control unit are connected to the main housing from two opposite sides of the main housing;

Optionally, in an example of the electromechanical brake, the locking device is pre-assembled and then mounted to the main housing.

Optionally, in an example of the electromechanical brake, the locking device housing of the locking device comprises a limiting feature matched with the main housing, and the locking device housing further comprises a bolt bore so as to be connected with a bolt passing through a wall of the main housing.

Optionally, in an example of the electromechanical brake, the electromechanical brake further comprises an adapter mounted in the main housing, the electronic control unit is electrically connected with the electromagnet and the brake motor respectively through the adapter, the electromagnet comprises a terminal connected with the adapter, the terminal is toward the adapter, or the terminal is toward the end cap.

The electromechanical brake according to an example of the present disclosure is more compact in structure and more convenient to assemble.

### BRIEF DESCRIPTION OF THE DRAWINGS

With reference to the accompanying drawings, the content disclosed in the present application is to become understandable more easily. It will be readily understood by those skilled in the art that these drawings are for purposes of illustration only and are not intended to limit the scope of protection of the present application. Additionally, similar numerals in the figures are used to represent similar components, wherein:

FIG. 1 shows an exploded view of an electromechanical brake according to an example when assembled to a hub;

FIG. 3 shows an exploded view of an electromechanical brake according to a first example of the present disclosure;

FIG. 4 shows a schematic diagram of an electromechanical brake according to an example of the present disclosure;

FIG. 5 shows an exploded view of an end cap and a locking device according to the first example of the present disclosure;

FIG. 6 shows a stereoscopic view of a rotating lever according to the first example of the present disclosure;

FIG. 7 shows an assembled view of the end cap and the locking device according to the first example of the present disclosure;

FIG. 8 shows an exploded view of the locking device according to the first example of the present disclosure;

FIG. 9 shows a stereoscopic view of the electromechanical brake according to the first example of the present disclosure when the end cap is removed;

FIG. 10 and FIG. 11 show a front view and a stereoscopic view of the locking device according to the first example of the present disclosure in an idle state, respectively;

FIG. 12 shows a front view of the locking device according to the first example of the present disclosure during a transition from the idle state to a working state;

FIG. 13 shows a front view of the locking device according to the first example of the present disclosure in the working state;

FIG. 14 shows a partial design dimension of the locking device according to the first example of the present disclosure;

FIG. 15 shows a schematic view of an end cap assembly of the electromechanical brake according to the first example of the present disclosure when the end cap is assembled;

FIG. 16 shows a schematic diagram of an electronic control unit of the electromechanical brake according to the first example of the present disclosure when assembled;

FIG. 18 shows a partial exploded view of an electromechanical brake according to a second example of the present disclosure;

FIG. 19 shows a stereoscopic view of an end cap and a locking device of the electromechanical brake according to the second example of the present disclosure;

FIG. 20 shows an exploded view of the end cap and the locking device of the electromechanical brake according to the second example of the present disclosure;

FIG. 21 shows a stereoscopic view of a rotating lever according to the second example of the present disclosure;

FIG. 22 and FIG. 23 show a front view and a rear view of the locking device according to the second example of the present disclosure in an idle state, respectively;

FIG. 24 and FIG. 25 show a stereoscopic view and a front view of the locking device according to the second example of the present disclosure in the idle state, respectively;

FIG. 26 shows a schematic view of an end cap of the electromechanical brake according to the second example of the present disclosure when assembled;

FIG. 27 shows a schematic view of the electromechanical brake according to the second example of the present disclosure when assembled;

FIG. 28 shows a stereoscopic view of an electromechanical brake according to a third example of the present disclosure;

FIG. 29 shows a partially exploded view of the electromechanical brake according to the third example of the present disclosure;

FIG. 30 shows a stereoscopic view of an end cap and a locking device of the electromechanical brake according to the third example of the present disclosure;

FIG. 31 shows a stereoscopic view of a locking device according to the third example of the present disclosure;

FIG. 32 shows an exploded view of the end cap and the locking device of the electromechanical brake according to the third example of the present disclosure;

FIG. 33 shows a stereoscopic view of a pivot pin according to the third example of the present disclosure;

FIG. 34 and FIG. 35 show a stereoscopic view of a main housing according to the third example of the present disclosure and an enlarged view of a pivot pin containing hole therein, respectively;

FIG. 36 shows a stereoscopic view of an adapter of the electromechanical brake according to the third example of the present disclosure;

FIG. 37 shows a stereoscopic view of an electromechanical brake according to a fourth example of the present disclosure;

FIG. 38 shows an exploded view of the electromechanical brake according to the fourth example of the present disclosure;

FIG. 39 shows an exploded view of a locking device of the electromechanical brake according to the fourth example of the present disclosure;

FIG. 40 shows an assembled view of the locking device of the electromechanical brake according to the fourth example of the present disclosure;

FIG. 41 and FIG. 42 are views of different angles of the locking device and the main housing according to the fourth example of the present disclosure when assembled, respectively;

FIG. 43 shows a view when the locking device is assembled according to the fourth example of the present disclosure; and

FIG. 44 and FIG. 45 show views of an electromagnet and its assembly according to alternative examples, respectively.

### DETAILED DESCRIPTION

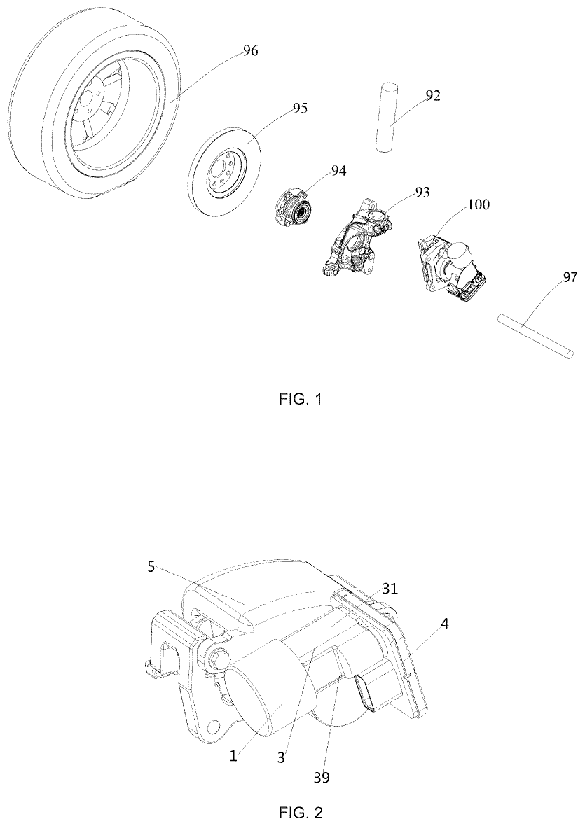

FIG. 1 shows a mounting diagram of an electromechanical brake, wherein a rotating shaft 97, a damper 92, a bearing 94, a steering knuckle arm 93, a brake disc 95 and a wheel 96 as well as an electromechanical brake 100 according to an example are shown, and the electromechanical brake is driven by a motor to provide a braking force by clamping the brake disc 95 with a brake caliper. During assembling, the electromechanical brake 100 is mounted on the steering knuckle arm 93, and meanwhile, the electromechanical brake 100 is contained in compact space on an inner side of the hub of the wheel 96.

The electromechanical brake 100 according to a first example of the present disclosure is described with reference to FIG. 2 to FIG. 16. The electromechanical brake 100 adopts a modular design and generally comprises a brake motor 1, a main module 3, a brake caliper module 5 and an electronic control unit 4. A spindle 301 coupled with the brake motor 1 is contained in the main module 3, and a direction along which the spindle 301 is herein is defined as an axial direction. The spindle 301 is driven by the brake motor 1 to rotate along a first direction to drive the brake caliper module 5 to perform a brake operation, i.e., be in friction with the brake disc 95, wherein a ratchet 33 is fixedly arranged on the spindle 301.

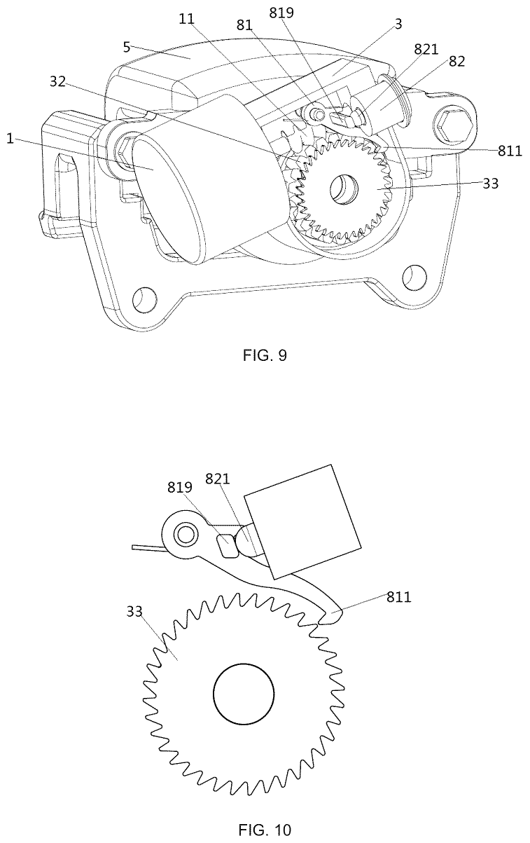

With reference to FIG. 4, the spindle 301 comprises a front end 302 and a rear end 303. The front end 302 of the spindle 301, i.e., an end close to the brake caliper module 5, forms a lead screw of the ball screw nut mechanism 304, while the ratchet 33 is disposed at the rear end 303 of the spindle 301, i.e., an end far away from the brake caliper module 5. A central portion (position between the front end and the rear end) of the spindle 301 may be provided with a worm gear 32 to receive torque from the brake motor 1, at least a portion of section of an output shaft 11 of the brake motor 1 may be configured as a worm 11, and the output shaft is oriented to intersect the axial direction and is meshed with the worm gear 32 to transmit the torque (see FIG. 9). Alternatively, the brake motor 1 may also drive the spindle 301 through a gear. The spindle 301 is driven by the brake motor 1 to rotate along the first direction, and drives a plunger 305 to move by way of the ball screw nut mechanism 304, such that the brake caliper module 5 grips the brake disc 95 to perform a brake function.

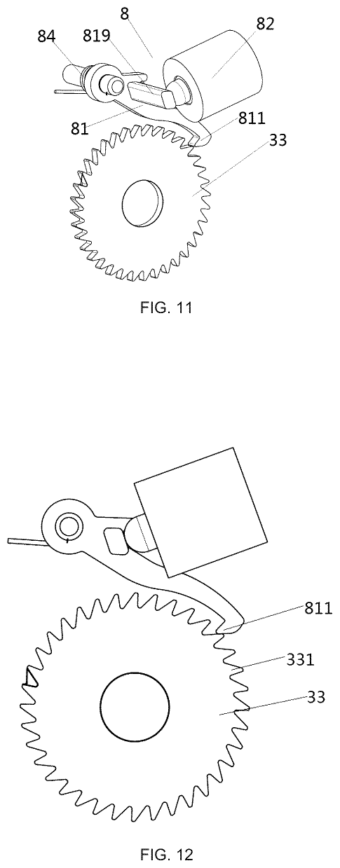

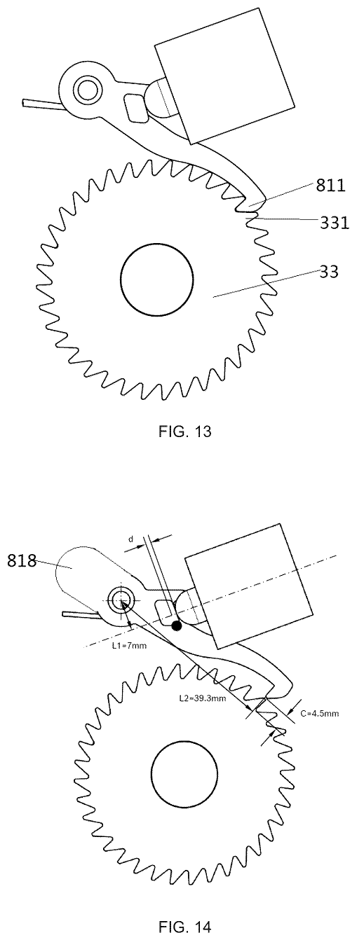

In another aspect, a locking device 8 is also provided to be matched with the ratchet 33 to achieve a parking brake function. The locking device comprises: a rotating lever 81, wherein the rotating lever 81 comprises an operating end 811, the rotating lever is capable of rotating between an idle position in which the operating end 811 is separated from the ratchet (as shown in FIG. 10 and FIG. 11) and a working position in which the operating end 811 is interlocked with the ratchet (as shown in FIG. 13); and an actuation member and a reset member, wherein the actuation member causes the rotating lever to rotate to the working position from the idle position, and the reset member causes the rotating lever to return to the idle position from the working position. Among them, the ratchet and the operating end of the rotating lever are disposed such that the operating end 811 interferes with the ratchet 33 in the working position to prevent the ratchet 33 from rotating in a second direction opposite to the first direction and to prevent the rotating lever 81 from returning to the idle position.

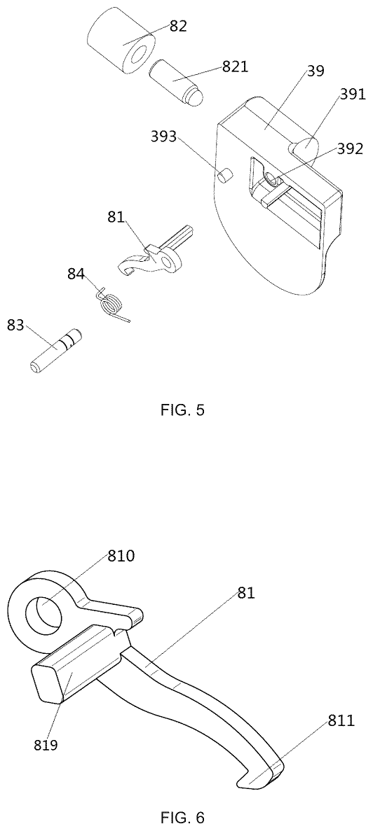

In some examples, the main module 3 of the electromechanical brake comprises a main housing 31 and an end cap 39, wherein a first end of the main housing 31 is connected to the brake caliper module 5, and a second end of the main housing 31 that is opposite to the first end is closed by the end cap 39. The spindle 301, the ratchet 33, the worm gear 32 and the locking device 8, etc. are contained in space between the main housing 31 and the end cap 39. In a first example, the locking device 8 is disposed in the end cap 39. Specifically, referring to FIG. 5, in some examples, the end cap 39 comprises a body portion (lower portion) generally used to cover a ratchet position in the main housing and an additional portion (upper portion) generally used to cover a worm position in the main housing, the additional portion of the end cap has an additional containing cavity 391 that contains the actuation member of the locking device 8, and in this example, the actuation member is the electromagnet 82 and is disposed in the additional containing cavity 391 of the end cap. In the present example, the rotating shaft 83 of the rotating lever 81 is connected between a bore 392 of the end cap and a bore (not shown in the figure) in a corresponding position of the main housing, and the rotating lever 81 is rotatably fixed to the rotating shaft 83, for example, the rotating shaft 83 passes through a shaft hole 810 of the rotating lever 81. In the specific example shown in FIG. 8, the rotating lever 81 is positioned axially on the rotating shaft 83 through slots 831, 832 on the rotating shaft 83 and corresponding clamping rings 833, 834, while opposite ends 835, 836 of the rotating shaft 83 are in interference fit to the bores of the end cap 39 and the main housing 31, respectively. In this example, the reset member is a torsion spring 84 that is disposed on the rotating shaft 83 and connected to the rotating lever 81.

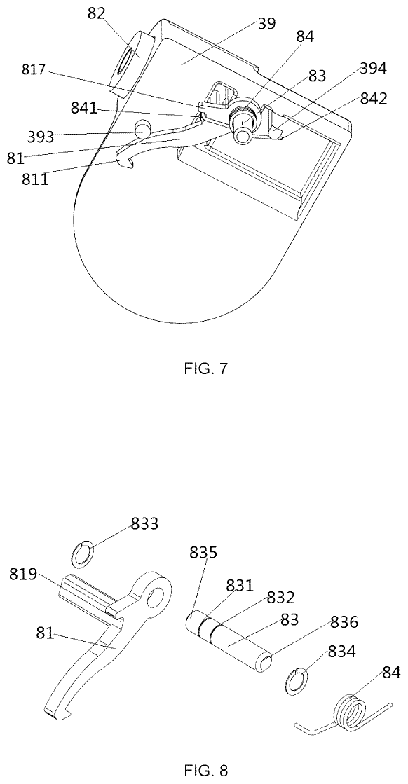

More specifically, referring to FIG. 7, a first end 841 of the torsion spring 84 abuts against a hook part 817 of the rotating lever 81, the other end 842 of the torsion spring is fixed, for example, abuts against a first protrusion part 394 on the end cap, and the torsion spring 84 is pre-compressed or pre-stretched, thereby providing a reset elastic force. In addition, a second protrusion part 393 is also provided on the end cap with the function of limiting the rotating lever 81 when the rotating lever is reset by the resilient member; and in some examples, the second protrusion part 393 may be wrapped with a cushioning material to provide cushioning and reduce bump sound.

In some examples, the action end 819 of the rotating lever 81 extends axially to be used to be in contact with the actuation mechanism, such as the execution end 821 of the electromagnet 82 to receive power (as shown in FIG. 8). In the first example, the rotating lever 81 is in the same plane as the ratchet 33, which is located approximately on one side of the ratchet that is close to the worm of the brake motor, and the rotating lever 81 receives rotation power by way of the action end 819 extending axially.

Referring to FIG. 10 to FIG. 13, the ratchet 33 rotates along with the spindle 301 within the first plane, the rotating lever 81 is disposed to rotate in the first plane, in the idle position, the rotating lever 81 is located on a radial outer side of the ratchet 33 (worm side), and ratches 331 of the ratchet 33 are located on a periphery of the ratchet 33. In some examples, the operating end 811 is configured as a hook part, and in the working position, the hook part of the operating end 811 hooks one of the ratches 331 on the periphery of the ratchet, thereby achieving interlocking. More specifically, FIG. 13 is taken as an example, wherein the counter-clockwise direction corresponds to the first direction in which the ratchet 33 rotates when receiving the drive of the brake motor 1, when the brake motor 1 stops working, the ratchet 33 has a tendency to rotate in a second direction opposite to the first direction (clockwise direction in FIG. 13), and the ratches 331 will be locked with the hook part of operating end 811, thereby achieving interlocking; and at the time, even the electromagnet 82 is powered off, i.e. its execution end 821 retracts back, the ratches 331 and the operating end 811 cannot be retracted. Conversely, when the ratchet 33 is rotated again along the first direction (in the counter-clockwise direction in the FIG. 13) under the action of the brake motor 1, the ratches 331 will guide the rotating lever 81 to rotate towards the idle position under the resetting elastic force of the torsion spring 84, thereby releasing both the rotating lever 81 and the ratchet 33.

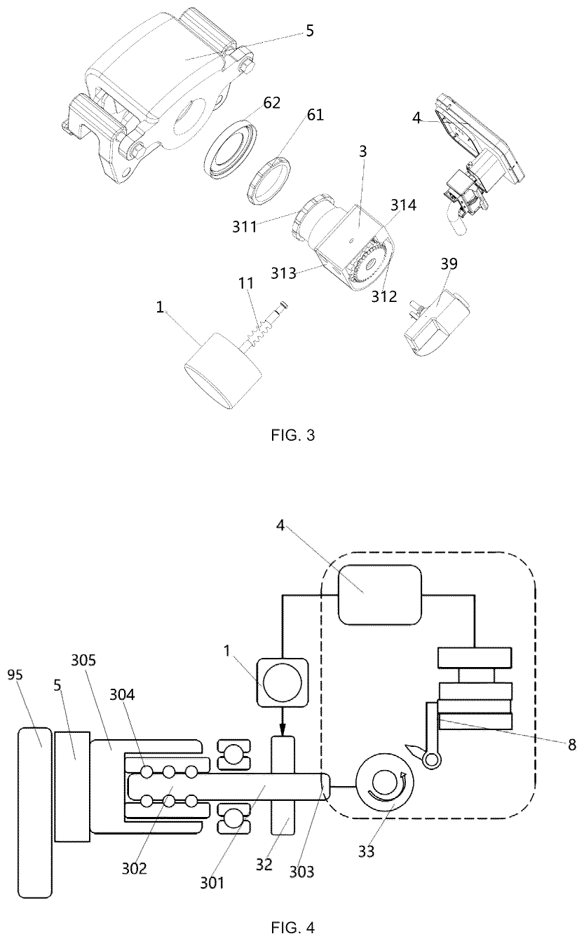

Referring to FIG. 3, the electromechanical brake according to the present disclosure adopts the modular design, and comprises a main module 3, and a brake caliper module 5 mounted at a distal end of the main module 3; and a fastening nut 61 and a sealing ring 62 are disposed therebetween. The main module 3 comprises a main housing 31 and an end cap 39, the main housing 31 contains a spindle 301, a ball screw nut mechanism 304, a ratchet 33, a worm gear 32, and a locking device 8, etc. The first end 311 of the main housing 31 is connected to the brake caliper module 5, and the second end 312 of the main housing 31 that is opposite to the first end is closed by the end cap 39. The brake motor 1 and the electronic control unit 4 are integrated to opposite sides of the main module 3, such as the first side 313 and the second side 314. It will be understood that operation of the brake motor 1 and the electromagnet 82 of the locking mechanism 8 is controlled by the electronic control unit 4. Specifically, as shown in FIG. 4, the brake motor 1 and the electromagnet 82 are connected to the electronic control unit 4. In parking brake control, upon receiving a parking brake signal, the electronic control unit 4 controls the brake motor 1 to rotate the spindle 301 along a first direction, thereby driving the brake caliper module 5 to establish predetermined brake torque, even if the brake caliper clamps the brake disc 95. Subsequently, the electronic control unit 4 controls the electromagnet 82 to act on the rotating lever 81 to rotate from the idle position to the working position, at this time, the hook part of the operating end of the rotating lever 81 is not necessarily to be aligned with a gap between the ratches 331 of the ratchet 33 (e.g., as shown in FIG. 12), and the brake motor 1 is controlled to slightly rotate (e.g., a position of one tooth) along the second direction to cause the operating end 811 of the rotating lever to move to the working position as shown in FIG. 13 to be interlocked with the ratches 331 of the ratchet 33, and at this time, the electromagnet 82 and the brake motor 1 may be powered off. As the rotating lever 81 is interlocked with the ratchet 33, the brake caliper module 5 is still capable of retaining the brake torque even if the electromagnet 82 and the brake motor 1 are powered off, so that in the parking brake condition of the vehicle, the electromagnet 82 does not need to remain in operation, thereby reducing the risk of damage to the electromagnet 82 due to long-term operation. When the vehicle needs to be restarted and only the brake motor 1 needs to be controlled to rotate, the ratchet 33 will rotate along the first direction, and the rotating lever 81 will return to the idle position under the guidance of the ratches of the ratchet 33 and under the action of the reset member until the next parking brake.

With continued reference to FIG. 14, in some examples, a maximum engagement depth c of the ratches 331 of the ratchet 33 and the rotating lever 81 is greater than 3 mm, e.g., the maximum engagement depth c of the ratches 331 of the ratchet 33 is 4.5 mm to ensure stability when the two are interlocked. Further, a second force arm L2 from the operating end of the rotating lever 81 to a rotation center is more than 3 times a first force arm L1 from the action end to the rotation center, for example, in the example shown in the figures, the second force arm L2 is 39.3 mm, the first force arm L1 is 7 mm, the second force arm L2 is more than 5 times the first force arm L1, and such setting may reduce a displacement d of the electromagnet 82. On the other hand, the rotating lever 81 may have a counterweight part 818, such that the center of gravity of the rotating lever is closer to the rotation center, such that the requirement for the capability of the electromagnet 82 may be reduced, i.e., the electromagnet 82 may have a smaller thrust and therefore have a smaller volume.

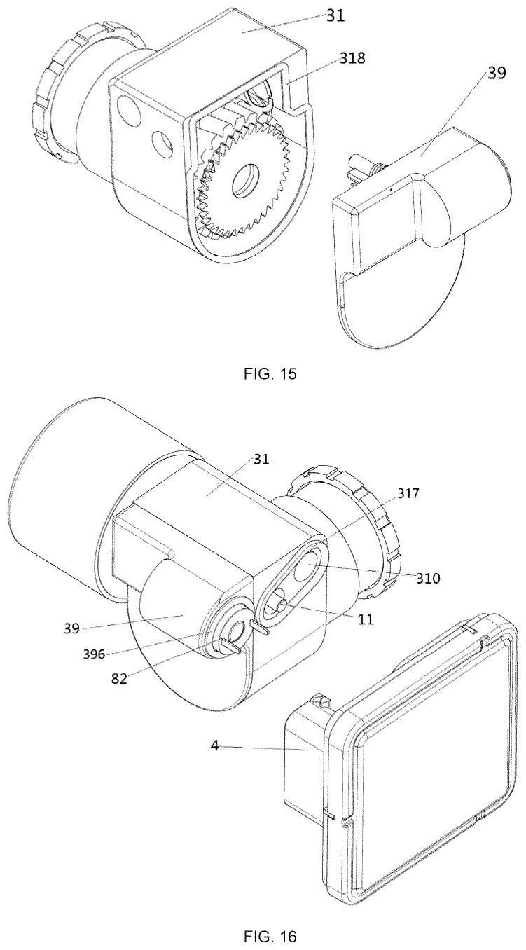

With continued reference to FIG. 15 and FIG. 16, the end cap 39 to which the locking device 8 is mounted in advance is assembled to the main housing 31, and a first sealing piece 318 is disposed between the main housing 31 and the end cap 39 to provide a seal therebetween. Subsequently, the electronic control unit 4 is assembled to the main module 3, and the end cap 39 has a port for the connection between the electromagnet 82 and the electronic control unit 4, and a second sealing piece 396 is disposed around the port. The main housing 31 also has a port facing the electronic control unit, wherein an output shaft 11 of the brake motor is exposed, and a position sensor may be disposed thereon, so that an angular position of the output shaft is monitored by the electronic control unit 4. An additional bore 310 may be used, for example, to arrange a line for connecting the brake motor 1 and the electronic control unit 4. A third sealing piece 317 surrounds the output shaft 11 of the brake motor 1 and the bore 310 to provide an additional seal. From the above structure, it can be seen that the electromechanical brake according to the first example of the present disclosure is compact in structure, reasonable in arrangement and convenient to assemble, and the modular design facilitates subsequent maintenance.

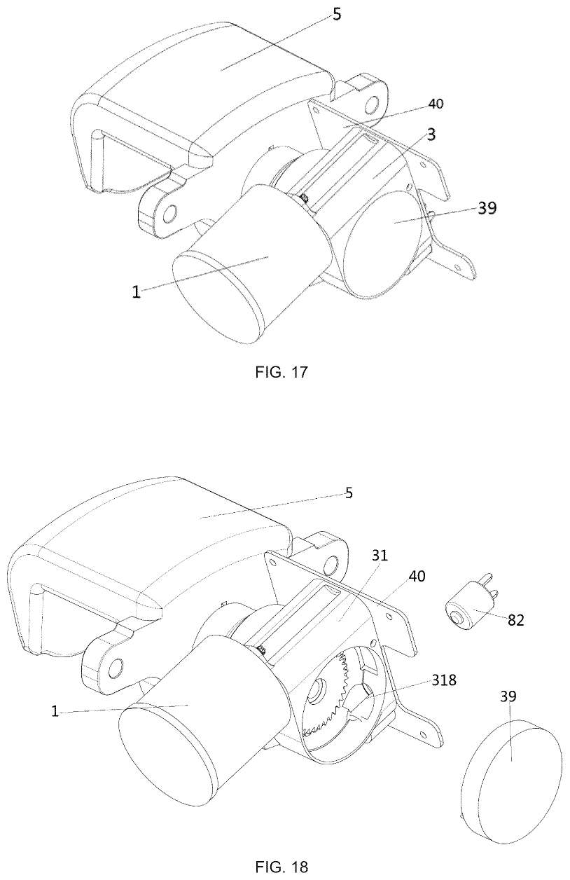

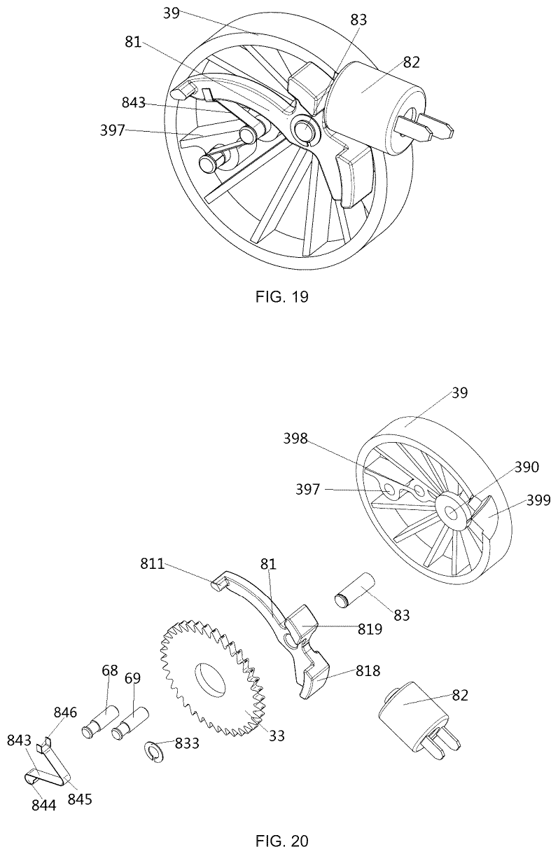

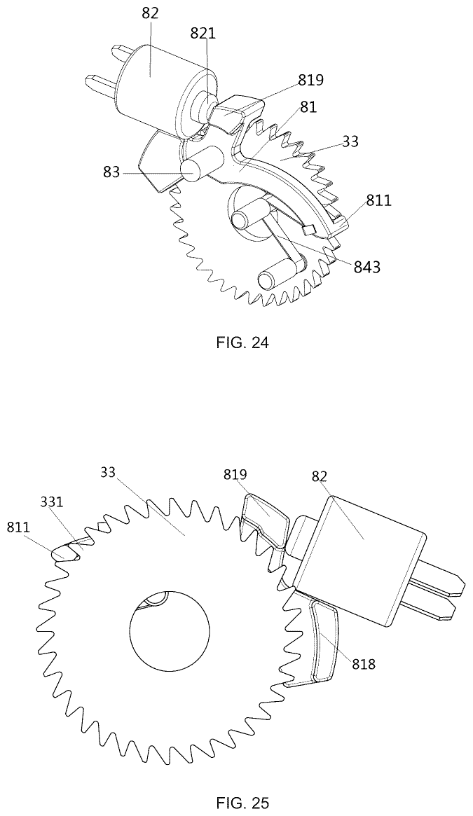

With continued reference to FIG. 17 to FIG. 27, a second example of the present disclosure is described, in which only a back plate 40 of the electronic control unit is used in place of the electronic control unit 4, and other identical components are indicated by the same reference numerals. In this example, the second end of the main housing 31 of the main module 3 has a cylindrical notch, and the end cap 39 is also disposed in a generally disc shape. In this example, the locking device 8 is also substantially integrated in the end cap 39, and the actuation member, i.e. the electromagnet 82 is provided at the main housing 31. Specifically, an electromagnet containing cavity 318 is provided at the sidewall of the cylindrical notch, the electromagnet 82 is contained at the electromagnet containing cavity 318, and the end cap 39 also has a wall 399 (FIG. 20) matched with the cylindrical profile of the electromagnet 82, such that the electromagnet 82 is located between the main housing 31 and the end cap 39 and is in contact with them when installed in place. With reference to FIG. 19, when the electromagnet 82 is mounted in place, its execution end 821 faces the rotating lever 81, and a connection port on a back side of the electromagnet 82 faces the electronic control unit 4.

With continued reference to FIG. 20, it can be seen that the inner side of the end cap 39 has a mounting hole 390 where a rotating lever rotating shaft 83 is arranged, and bores 397, 398 for arranging a first locating pin 68 and a second locating pin 69; and in addition, the inner side of the end cap 39 also has a plurality of stiffening bars that diverge from the mounting hole 390. One end of the rotating shaft 83 is matched to the mounting hole 390 and passes through the shaft hole 810 of the rotating lever 81 to be positioned axially by the clamping ring 833. The folding spring 843 is mounted on the first locating pin 68 and the second locating pin 69; and specifically, the first end 844 of the folding spring 843 is fixed to the first locating pin 68, its bending part 845 bypasses the second locating pin 69, its second end 846 abuts against the rotating lever, and the second end 846 is formed, for example, as a slot or a collar to better support an arm of the rotating lever that is connected to the operating end 811.

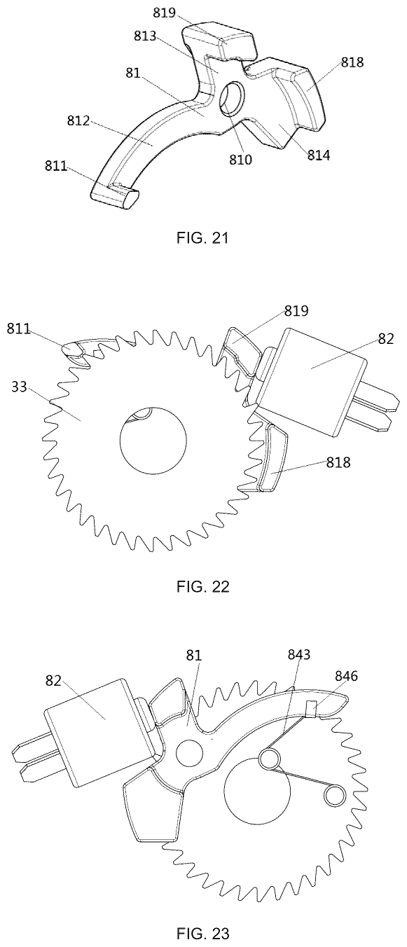

With continued reference to FIG. 21, a specific structure of the rotating lever 81 is shown. The rotating lever 81 comprises a first arm 812, a second arm 813 and a third arm 814 that extend from the shaft hole 810 along three directions; end parts of the first arm 812, the second arm 813 and the third arm 814 extend axially out of an operating end 811, an action end 819 and a counterweight part 818, respectively, the operating end 811 is used for being interacted with the ratchet 33 in a manner detailed above in connection with the first example, the action end 819 receives a pulling force of the electromagnet 82, and the counterweight part 818 is arranged so that the center of gravity of the rotating lever is close to a pivot center. As can be seen from FIG. 21 to FIG. 25, the rotation plane of the ratchet 33 is used as a first plane, the rotating lever 81 rotates within a second plane parallel to the first plane, and the second plane is further away from the brake caliper module 5. In some examples, the rotating lever 81 is at least partially coincident in the axial direction with the ratchet 33, and its operating end 811, action end 819 and counterweight part 818 extend axially from the second plane to the first plane and are located on the radial outer side of the ratchet, respectively. More specifically, the action end 819 and the counterweight part 818 are always located on the radial outer side of the ratchet 33 during rotation of the rotating lever between the idle position and the working position, while the manner of interaction between the operating end 811 and the ratches of the ratchet is substantially the same as that described in the first example, which is not repeated here. Through this arrangement, the locking device 8 may only increase the size of the main module 1 in a small amount in the axial direction without increasing the size in other directions, making the main module 1 more compact.

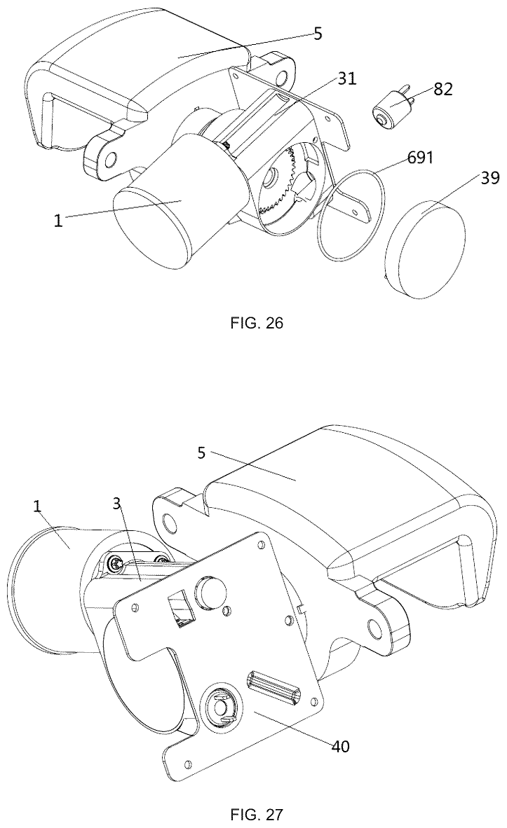

With continued reference to FIG. 26 and FIG. 27, the end cap 39 is shaped as a disc and is capable of being assembled into the cylindrical notch of the main housing 31, while the sealing piece 691 is provided between the two. Similarly, a connection port of the electromagnet 82 and the end part of the motor output shaft extend to the electronic control unit 4.

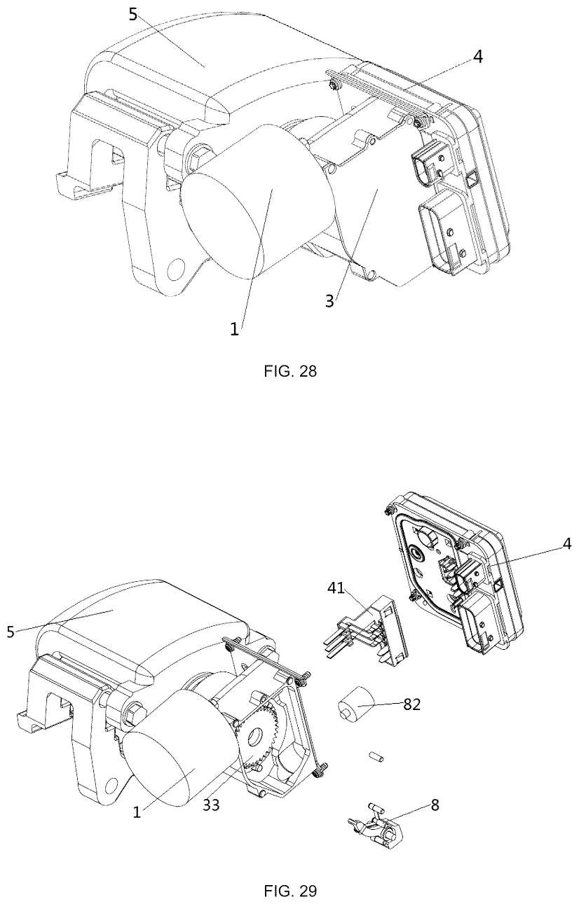

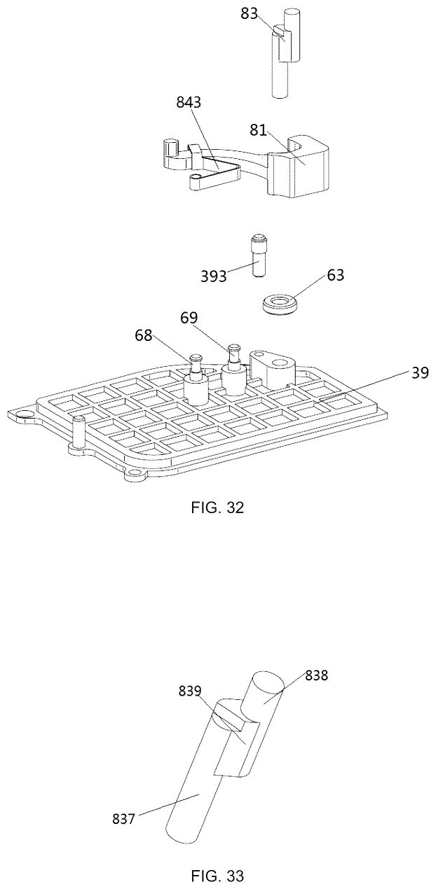

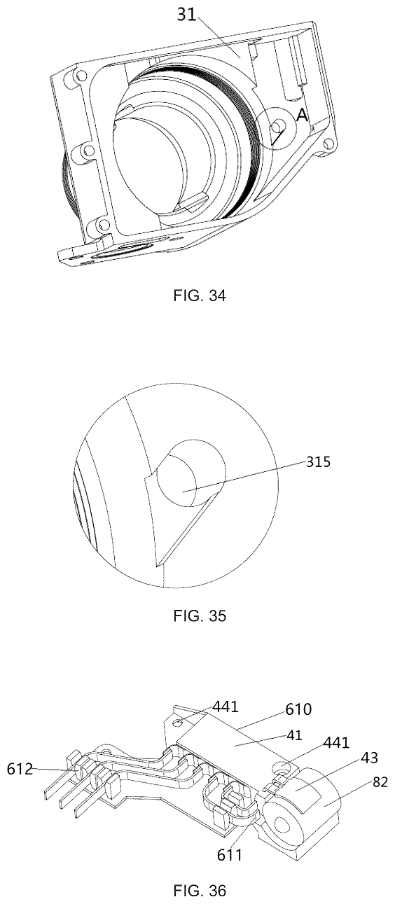

A third example according to the present disclosure is continued to be introduced with reference to FIG. 28 to FIG. 36. In this example, the adapter 41 is provided between the electronic control unit 4 and the electromagnet 82 and the brake motor 1, and in some examples, the adapter 41 may comprise a clamping part 43 that receives the electromagnet 82, as shown in FIG. 36. The adapter 41 also comprises a plurality of positioning mounting holes 441. Additionally, the adapter 41 also comprises a socket 610 facing a back face of the electronic control unit 4, two terminals 611 connected to the electromagnet, and three terminals 612 connected to the three-phase brake motor 1.

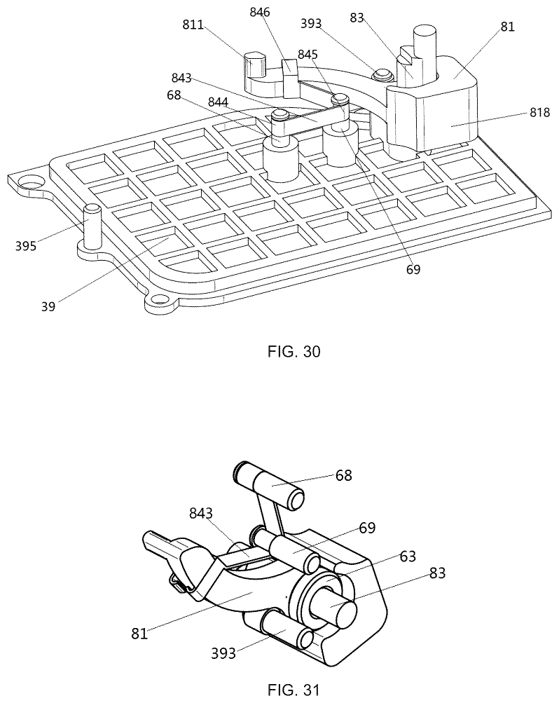

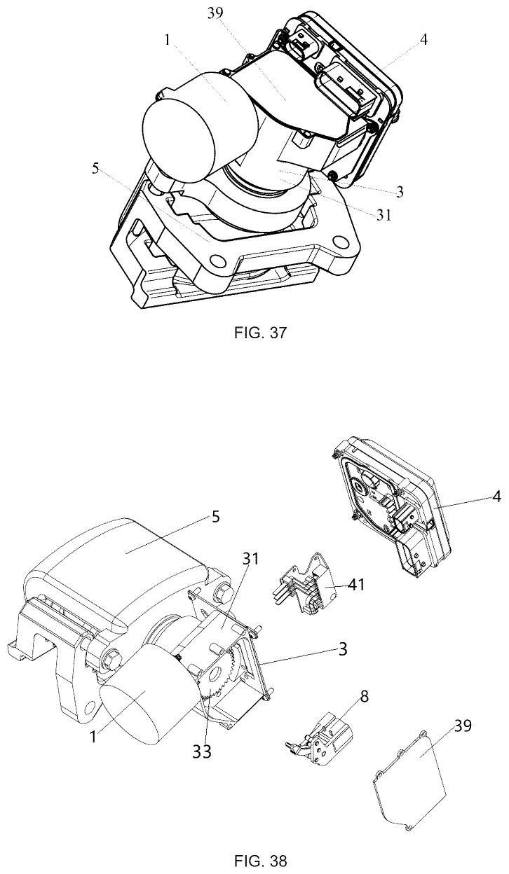

Referring to FIG. 30 and FIG. 31, a locking device in combination with the end cap 39 and a separate locking device are shown. In some examples, the end cap 39 is designed with at least one positioning post 395 inserted into the mounting hole of the main housing for bearing a counter force borne by the end cap when the ratchet is interlocked with the rotating lever. In addition, in the third example, the reset member is similar to the folding spring in the second example, the rotating shaft 83 is configured to have a first post portion 837, a second post portion 838 and a transition portion 839 due to the inability to open a bore at a corresponding position at the main housing, and the first post portion 837 and the second post portion 838 are biased and are connected by the transition portion 839. The first post portion 837 passes through a positioning pad 63 to be inserted into the bore on the end cap, the second post portion 838 is inserted into a positioning hole 315 of the main housing 31, and the positioning hole 315 is disposed to contain both the second post portion 838 and the transition portion 839, thereby inhibiting rotation of the rotating shaft 83. The rotating shaft 83 passes through the rotating lever 81, the operating end 811 of the rotating lever 81 interacts with the ratchet 33 in the manner detailed above in connection with the first example. The electromechanical brake 100 according to a fourth example of the present disclosure is described with reference to FIG. 37 to FIG. 45. The electromechanical brake 100 adopts a modular design and generally comprises a brake motor 1, a main module 3, a brake module 5 and an electronic control unit 4. The electronic control unit 4 may be connected with the brake motor 1 and the actuation mechanism of the locking device 8, such as an electromagnet through the adapter 41. The main module 3 may comprise a main housing 31 and an end cap 39, in which a spindle 301 coupled with the brake motor 1 may be contained, the spindle 301 is driven by the brake motor 1 to rotate along a first direction to drive the brake module 5 to perform a brake operation, i.e., be in frictional contact with the brake disc 95, wherein a ratchet 33 is fixedly arranged on the spindle 301.

Further, as shown in FIG. 38, the electromechanical brake according to the present disclosure comprises a main module 3 and a brake module 5 mounted at a distal end of the main module 3. The main module 3 comprises a main housing 31 and an end cap 39, the main module 3 contains the spindle 301, a ball screw nut mechanism 304, a ratchet 33, a worm gear 32, a locking device 8 and an adapter 41. The first end of the main housing 31 is connected to the brake module 5, and the second end of the main housing 31 that is opposite to the first end is closed by the end cap 39. The brake motor 1 and the electronic control unit 4 are integrated at opposite sides of the main module 3, the output shaft of the brake motor 1 is inserted into the main housing 31 to be meshed with the worm gear on the spindle 301, the end of the output shaft can extend to the electronic control unit 4, and the angular position of the output shaft of the brake motor 1 is detected by the sensor. It will be understood that the operation of the brake motor 1 and the actuation member of the locking mechanism 8 is controlled by the electronic control unit 4, and the electronic control unit 4 may be connected to the brake motor 1 and the electromagnet 82, for example, through the adapter 41.

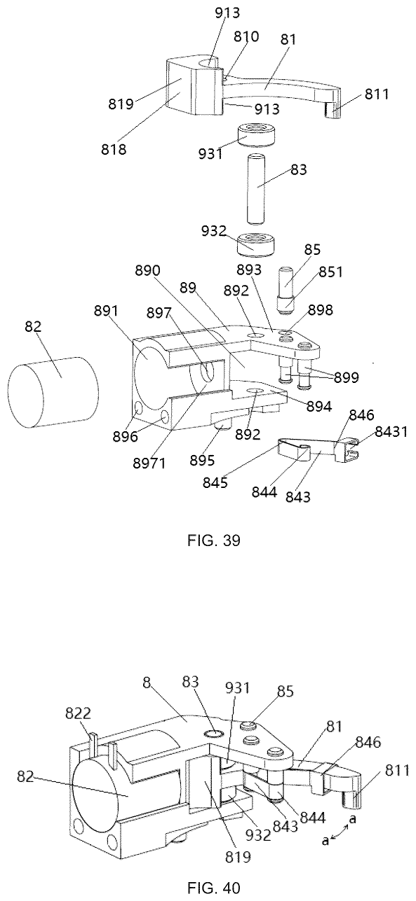

With continued reference to FIG. 39 and FIG. 40, a stereoscopic view of the assembly state and the exploded state of the locking device 8 is shown. The locking device 8 comprises: a locking device housing 89, which is connected to a rotating lever 81 of the locking device housing 89 through a rotating shaft 83, the rotating lever 81 comprises an operating end 811, the rotating lever 81 is capable of rotating between an idle position and a working position, the operating end 811 of the rotating lever 81 is separated from the ratchet 33 in the idle position, and the operating end 811 of the rotating lever 81 is interlocked with the ratchet 33 in the working position. The locking device 8 also comprises an actuation member and a reset member, the actuation member causes the rotating lever 81 to rotate from the idle position to the working position, and the reset member causes the rotating lever 81 to return from the working position to the idle position. The ratchet 33 and the operating end 811 of the rotating lever are disposed such that the operating end 811 interferes with the ratchet 33 in the working position to prevent the ratchet 33 from rotating in a second direction opposite to the first direction and to prevent the rotating lever 81 from returning to the idle position.

In some examples, the locking device housing 89 comprises a first cavity 891 for containing the actuation member and a second cavity 890 for containing a rotating shaft 83, a rotating lever 81 and a reset member. In some examples, the actuation member is the electromagnet 82. The electromagnet 82 may generally have a cylindrical shape and comprise terminals 822 for electrical connection and an execution end 821 that performs linear displacement (see FIG. 44). The first cavity 891 may be configured to be matched with the electromagnet 82 in shape, for example, the first cavity 891 may be configured as a cylindrical cavity matched with the cylindrical electromagnet. In alternative examples, the actuation member may adopt any other suitable structure, and the shape of the first cavity 891 may also be adaptively modified. In alternative examples, the actuation member may be any other component capable of driving movement of the rotating lever.

In some examples, the first cavity 891 and the second cavity 890 are spaced apart by an intermediate wall 8971, the intermediate wall 8971 has a bore 897 that allows an execution end 821 of the electromagnet 82 to pass through, the execution end 821 of the electromagnet 82 can translationally pass through the bore 897, thereby acting on the rotating lever 81, which will be detailed below. As shown in FIG. 39, the electromagnet 82 may be inserted into the first cavity 891 from one end of the first cavity 891 that is opposite to the intermediate wall 8971, and the shape of the first cavity 891 radially limits the electromagnet 82.

In some examples, the second cavity 890 comprises opposing walls 893, 894, the rotating shaft 83 is connected between mounting holes 892 of the opposing walls 893, 894, for example, be connected by riveting or other connection manners, etc. The rotating lever 81 comprises a shaft hole 810 for mounting on the rotating shaft 83 in a sleeving mode; and in addition, in some examples, washers 931, 932 may also be provided, and the washers 931, 932 are also provided on both sides of the rotating lever 81 on the rotating shaft 83, thereby being provided between the rotating lever 81 and the opposing walls 893, 894 to axially limit the rotating lever 81. In some examples, the rotating lever 81 comprises concave parts 913 corresponding to the washers 931, 932. The washers 931, 932 may be made of, for example, suitable materials such as plastic, rubber, or metal.

In some examples, the reset member is a folding spring 843 and is mounted on a pin 899 extending from the opposing walls 893, 894. In the illustrated examples, there are two pins 899 connected to the upper wall 893, the folding spring 843 comprises a first end 844 connected to the first pin, a bending part 845 bypassing the second pin and a second end 846 connected to the rotating lever, the second end 846 can be arranged in a position of the rotating lever 81 that is close to the operating end 811, thereby providing a reset force by an elastic force of the folding spring 843. In alternative examples, the reset member may also adopt a coil spring, a disc spring, etc., is mounted to the locking device housing and applies an elastic force to the rotating lever 81. In some examples, the second end 846 of the folding spring 843 is configured with a barb 8431, thereby limiting the rotating lever 81 to prevent the rotating lever 81 from being separated from the second end 846 when vibrated and impinged.

In some examples, the locking device 8 further comprises a banking pin 85 extending from one of the opposing walls 893, 894, the banking pin 85 is configured to limit the rotating lever 81 when the rotating lever 81 returns from the working position to the idle position under the effect of the folding spring 843 of the reset member. In some examples, the banking pin 85 is wrapped with a cushion collar 851, such as a rubber layer, thereby avoiding noise generated when the rotating lever 81 impinges with the banking pin 85.

In some examples, the rotating lever 81 comprises an action end 819 in contact with the actuation member, for example, it is in contact with the execution end 821 of the electromagnet 82 to receive power for driving the rotating lever 81 to rotate, and the shaft hole 810 of the rotating lever 81 being located between the operating end 811 and the action end 819. For the compact overall structure of the locking device 8, the action end 819 is closer to the shaft hole 810 than the operating end 811, and a force arm is shorter for the electromagnet 82, such that the capability requirement for the electromagnet 82 is greater, thereby increasing the volume of the electromagnet 82. In some examples, the action end 819 is configured to have a counterweight part 818, such that a center of gravity of the rotating lever 81 is located near the shaft hole 810, thereby reducing the requirement for the capability of the electromagnet 82. In other aspect, in some examples, the operating end 811 comprises an axial extension part extending perpendicular to a rotation plane of the rotating lever 81, thereby interacting with the ratchet 33. In alternative examples, the operating end 811 may have a pawl, any structure such as the hook part or pin that is capable of interlocking with the ratchet 33.

As shown in FIG. 40 to FIG. 42, the locking device 8 is first pre-assembled, including assembly of the electromagnet 82, the rotating lever 81, the folding spring 843 and the banking pin 85, etc. to the locking device housing 89. In this state, as the execution end 821 of the electromagnet 82 protrudes or retracts based on the control signal, the rotating lever 81 correspondingly uses the rotating shaft 83 as a circle center to rotate upward in the in-plane a-a direction, i.e. corresponding to rotation between the idle position and the working position. Once installed in place, a rotation range of the rotating lever 81 is limited by the banking pin 85 and the ratchet 33.

The pre-assembled locking device 8 is mounted into the main housing 31. In some examples, the locking device housing 89 of the locking device 8 may comprise a limiting feature that is matched with the main housing 31, for example, the wall 894 may comprise a protrusion part 895 that is aligned and matched with a slot 310 on one platform of the main housing 31, and the limiting feature ensures that the locking device 8 is capable of keeping positioned when bearing a counter-acting force of the ratchet 33. In addition, the locking device housing 89 further comprises a bolt bore 896 to be connected with a bolt 91 passing through a wall of the main housing 31, e.g., in the illustrated example, the locking device housing 89 has bolt bores 896 at two corners of one end where the actuation member is located, the bolt bores are aligned with the bore 319 on the main housing 31, and the bolt 91 passes through the bore 319 to be connected to the bolt holes 896 of the locking device housing 89. The limiting feature and the bolt fastening are matched to fix the locking device 8 in the main housing 31. In alternative examples, the locking device 8 as a whole may also be fixed in the main housing 31 by other suitable ways, for example, snap-connection, fasteners or mating of glue with the limiting features, and the like.

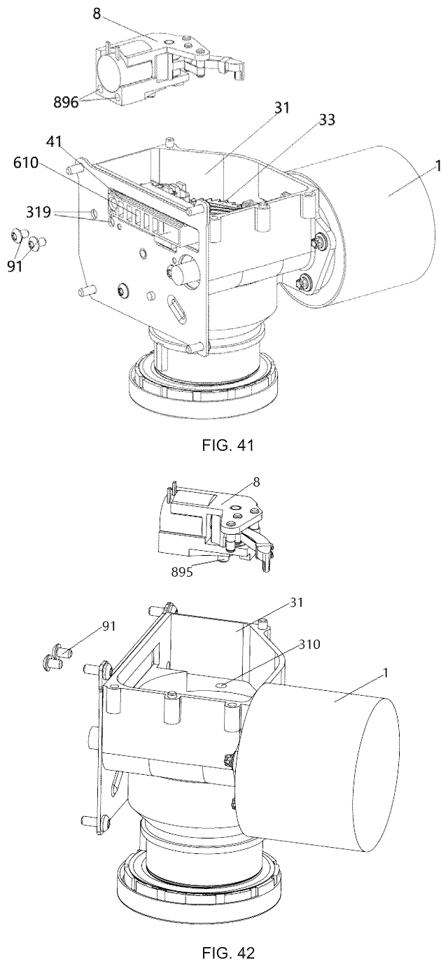

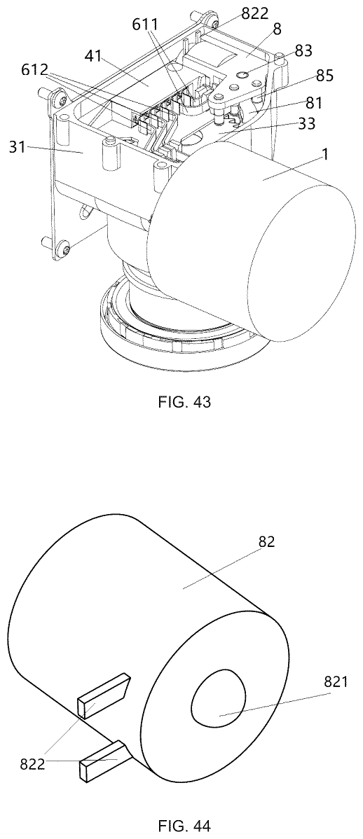

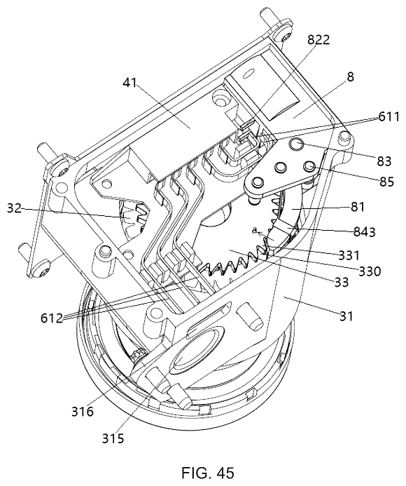

As can be seen from FIG. 41 and FIG. 43, the adapter 41 is also mounted in the main housing 31, wherein the adapter 41 comprises a socket 610, and the socket 610 is exposed to an end surface of the main housing 31 that faces the electronic control unit 4 for being connected to the adapter when the electronic control unit 4 is mounted. Meanwhile, the adapter also comprises a plurality of terminals 611, 612, wherein a portion 611 of the plurality of terminals is used for being connected to the actuation mechanism of the locking device 8, and another portion 612 of the plurality of terminals is connected to the brake motor 1. The actuation member, such as the electromagnet 82, comprises a terminal 822 connected to an adapter, and the terminal 822 may be located at a rear end of the electromagnet 82 that is opposite to the execution end 821. In the example shown in FIG. 43, when assembled in the main housing 31, the terminal 822 of the electromagnet 82 is towards the end cap 39 of the main housing, and a wire may be welded between the terminal 822 of the electromagnet and the terminal 611 of the adapter 41. As shown in FIG. 44 and FIG. 45, in alternative examples, the terminals 822 of the electromagnet 82 may also be disposed at the same end of the execution end 821, and the terminals 822 of the electromagnet 82 are towards the adapter 41 when assembled in the main housing 31.

An electronic brake device according to an example may be operable as follows: during a conventional driving process, the electronic control unit 4 controls the brake motor 1 to rotate to enable the spindle 301 to rotate along a first direction based on the stroke or input force of the brake pedal, thereby driving the brake module 5 to apply a brake torque corresponding to the stroke or input force of the brake pedal; and in this process, the rotating lever 81 of the locking device remains in the idle position at all times by the reset member. In control under the parking brake conditions, upon receiving a parking brake signal (like a hand brake or an electrical brake), the electronic control unit 4 controls the brake motor 1 to rotate to enable the spindle 301 to rotate along a first direction, thereby driving the brake module 5 to establish a predetermined brake torque, even if the brake caliper clamps the brake disc 95. Subsequently, the electronic control unit 4 controls the actuation member to act on the rotating lever 81 to rotate from the idle position to the working position, as shown by arrow a in FIG. 45; at this time, the operating end 811 of the rotating lever 81 is not necessarily to be aligned with the ratches 331 of the ratchet 33, and the brake motor 1 is controlled to slightly rotate (e.g., a position of one tooth) along the second direction to cause the operating end 811 of the rotating lever to move to the working position to be interlocked with the ratches 331 of the ratchet 33 (clamped in a gap 330 between the ratches 331), and at this time, the electromagnet 82 and the brake motor 1 may be powered off. Because it is in the working position, the ratchet 33 and the operating end 811 of the rotating lever are disposed such that the operating end 811 interacts with the ratchet 33 to prevent the ratchet 33 from rotating in a second direction opposite to the first direction and to prevent the rotating lever 81 from returning to the idle position. Thus, the brake module 5 is still capable of retaining the brake torque even if the electromagnet 82 and the brake motor 1 are powered off, so that in the parking brake condition of the vehicle, the electromagnet 82 does not need to remain in operation, thereby reducing the risk of damage to the electromagnet 82 due to long-term operation. Upon restart of the vehicle, the electronic control unit 4 causes the brake motor 1 to drive the spindle 301 to rotate slightly along the first direction; and due to the design of the ratches 331, the rotation of the ratchet 33 along the first direction will release the rotating lever 81, and the reset member will return the rotating lever 81 to the idle position until the next parking brake.

The electromechanical brake according to various examples of the present disclosure are described above. For the design of the locking device in various examples above, an important factor is its size. As described above in connection with FIG. 1, due to the limitation of the arrangement space of the electromechanical brake itself, the size of the locking device to achieve the parking brake function is required to be as small as possible. The design of the rotating lever of the locking device is particularly important, as is its relevance to the size of the electromagnet. In one aspect, it is desirable to minimize the displacement of the execution end 821 of the electromagnet 82 while ensuring sufficient displacement of the operating end. Thus, in some examples, as shown in FIG. 14, the locking device is configured such that the movement distance c of the operating end 811 of the rotating lever 81 during movement of the rotating lever 81 from the idle position to the working position is more than 3 times the movement distance d of the action end 819 of the rotating lever 81. In some examples, the movement distance c of the operating end 811 of the rotating lever 81 is more than 5 times the movement distance d of the action end 819 of the rotating lever 81, e.g., the c is approximately 0.8 mm, and the d is more than 4.5 mm. In the example shown in FIG. 8, the action end 819 is located on the same side of the shaft hole 810 as the operating end 811, but in other examples, the action end 819 is located on the opposite side of the shaft hole 810 as the operating end 811. The proportion of above displacement may be achieved by setting the position from the action end to the rotation axis, for example, the action end 819 is made to get close to the rotation axis, i.e., the shaft hole 810. The smaller displacement of the action end 819 corresponds to the smaller displacement of the electromagnet 82 and the smaller dimension.

In some examples, the rotating lever 81 further comprises a counterweight part 818 located at on second side of the shaft hole 810 that is opposite to the first side, such that a center of gravity of the rotating lever 81 is near the shaft hole 810. In some examples, the distance from the center of gravity of the rotating lever 81 to the shaft hole 810 is less than 1 cm. Bringing the center of gravity of the rotating lever 81 to get close to the center of gravity may cause the rotating lever 81 to rotate under a small actuation force. In order to reduce the displacement, the action end 819 is closer to the rotation center, which will result in less torque of the actuation force. Increasing the counterweight part 818 makes such small torque to ensure rotation of the rotating lever 81. The counterweight part 818 may be achieved in a variety of ways, but in order not to significantly increase the volume, the materials thereof may be changed, for example, the weight is increased by selecting heavier metal, or by constructing an extension part along the axial direction. To not significantly increase the volume, the maximum distance from the operating end 811 to the rotating shaft 83 is more than 3 times, for example, more than 5 times the maximum distance from the counterweight part 818 to the rotating shaft 83, so the counterweight part has a smaller radial dimension, and the weight relies primarily on axial extension. Taking the third example and the fourth example as examples, the counterweight part 818 is disposed on the action end 819 and extends axially from the action end 819 to both, such that the action end 819 has a greater thickness than the operating end. In the second example, the rotating lever 81 comprises a first arm 812, a second arm 813 and a third arm 814 that extend from the shaft hole 810 along three directions, and end parts of the first arm 812, the second arm 813 and the third arm 814 are configured as the operating end 811, the action end 819, and the counterweight part 818, respectively. In various examples, the operating end 811, the action end 819 and/or the counterweight part 818 have axial extension parts extending axially.

Further, for various examples, the locking device 8 may be pre-assembled separately, wherein the end cap 39 may be utilized as a bracket for various parts, and the separate locking device housing 89 may also be utilized as a bracket for various parts as shown in the fourth example. Through such arrangement, the locking device 8 may be pre-assembled on a separate production line and easily mounted into or assembled with the main housing produced by another production line, which avoids the problem of excessively long single production lines.

The electromechanical brake according to the present application is compact in structure; and during the parking brake, the actuation mechanism of the locking device does not need to be powered on, thereby avoiding its failure due to long-term power-up. On the other hand, the requirement for the capability and volume of the electromagnet is reduced by the special design for the rotating lever.

The specific examples described above in the present application are intended to only describe the principles of the present application more clearly, i.e., clearly illustrate or describe various components to make the principles of the present disclosure easier to understand. Within the scope of the present application, those skilled in the art can easily make various modifications or changes to the present application. Therefore, it should be understood that these modifications or changes are all comprised within the scope of the patent protection of the present application.

What is claimed is:

1. A locking device for an electromechanical brake, comprising:
a bracket;
a rotating lever having an operating end for being interlocked with a ratchet of the electromechanical brake, the rotating lever being connected to the bracket through a rotating shaft such that the rotating lever is rotatable between an idle position and a working position with the rotating shaft as a rotation axis;
an electromagnet configured to act on an action end of the rotating lever thereby causing the rotating lever to rotate from the idle position to the working position; and
a reset member configured to cause the rotating lever to return to the idle position from the working position,
wherein the locking device is configured such that a first movement distance of the operating end of the rotating lever is more than 3 times a second movement distance of the action end of the rotating lever during movement of the rotating lever from the idle position to the working position.

2. The locking device according to claim 1, wherein:
the operating end is located on a first side of a shaft hole that is matched with the rotating shaft, and
the rotating lever further comprises a counterweight part located on a second side of the shaft hole that is opposite to the first side such that a center of gravity of the rotating lever is near the shaft hole.

3. The locking device according to claim 2, wherein:
the counterweight part is disposed on the action end, or the rotating lever comprises a first arm, a second arm, and a third arm that extend from the shaft hole along three directions, end parts of the first arm, the second arm and the third arm are configured as the operating end, the action end and the counterweight part, respectively, and
the operating end, the action end and/or the counterweight part have axial extension parts extending along an axial direction.

4. The locking device according to claim 1, wherein a maximum distance from the operating end to the rotating shaft is more than 3 times a maximum distance from the counterweight part to the rotating shaft.

5. The locking device according to claim 1, wherein:
the bracket is a separate locking device housing,
the rotating lever is connected to the locking device housing through the rotating shaft, and
the locking device housing includes a first cavity configured to contain the electromagnet and a second cavity configured to contain the rotating shaft, the rotating lever and the reset member.

6. The locking device according to claim 5, wherein:
the first cavity is configured to be matched with the electromagnet in shape, the first cavity and the second cavity are spaced apart by an intermediate wall, the intermediate wall has a bore allowing an execution end of the electromagnet to pass through,
the second cavity comprises opposing walls, the rotating shaft is connected to mounting holes of the opposing walls, and
the rotating lever is arranged on the rotating shaft in a sleeving mode, and washers are arranged between the rotating lever and the opposing walls to axially limit the rotating lever.

7. A locking device according to claim 5, wherein:
the reset member is a folding spring and is mounted on pins extending from the opposing walls,
the folding spring includes a first end connected to a first pin, a bending part bypassing the second pin, and a second end connected to the rotating lever,
the locking device further includes banking pins extending from the opposing walls, the banking pins are configured to limit the rotating lever when the rotating lever returns to the idle position from the working position, and
the banking pins are wrapped with cushion collars.

8. The locking device according to claim 1, wherein:
the bracket forms an end cap of the main module of the electromechanical brake, the end cap has an additional containing cavity configured to contain an electromagnet, the electromagnet is disposed in the additional containing cavity, and
one end of the rotating shaft of the rotating lever is disposed in the bore of the end cap, the rotating lever is rotationally fixed to the rotating shaft, the reset member is a torsion spring disposed on the rotating shaft, a first end of the torsion spring abuts against a hook part of the rotating lever, and a second end of the torsion spring is fixed.

9. An electromechanical brake, comprising:
a brake motor;
a spindle coupled with the brake motor, the spindle being driven by the brake motor to rotate along a first direction to drive a brake module to perform a brake operation, wherein a ratchet is fixedly disposed on the spindle; and
the locking device according to claim 1, wherein the operating end is separated from the ratchet when the rotating lever of the locking device is in the idle position, and the operating end is interlocked with the ratchet when the rotating lever of the locking device is in the working position,
wherein the ratchet and the operating end of the rotating lever are disposed such that, when in the working position, the operating end interacts with the ratchet to prevent the ratchet from rotating along a second direction opposite to the first direction and to prevent the rotating lever from rotating towards the idle position.

10. The electromechanical brake according to claim 9, wherein:
the spindle comprises a front end and a rear end that are opposite, the front end of the spindle is coupled to the brake module through a ball screw nut mechanism, the ratchet is fixedly mounted at the rear end of the spindle, a worm gear is fixedly disposed in a middle section between the front end and the rear end of the spindle,
an output shaft of the brake motor is configured as a worm meshed with the worm gear on the spindle,
the electromechanical brake comprises: a brake motor, a main module, a brake module, and an electronic control unit, the main module comprises a main housing and an end cap, the spindle, the ball screw nut mechanism, the ratchet, the worm gear and the locking device are contained between the main housing and the end cap, a first end of the main housing is connected to the brake module, a second end of the main housing that is opposite to the first end is closed by the end cap, and the brake motor and the electronic control unit are connected to the main housing from two opposite sides of the main housing,
the locking device is pre-assembled and then mounted to the main housing, and
a locking device housing of the locking device comprises a limiting feature matched with the main housing, and the locking device housing further comprises a bolt bore to be connected with a bolt passing through a wall of the main housing.

11. The electromechanical brake according to claim 10, wherein:
the electromechanical brake further comprises an adapter mounted in the main housing,
the electronic control unit is electrically connected with the electromagnet and the brake motor through the adapter, respectively, and
the electromagnet comprises a terminal connected with the adapter, the terminal is toward the adapter, or the terminal is toward the end cap.

12. A locking device according to claim 1, wherein the locking device is configured such that the first movement distance of the operating end of the rotating lever is more than 5 times the second movement distance of the action end of the rotating lever.

13. The locking device according to claim 2, wherein a distance from the center of gravity of the rotating lever to the shaft hole is less than 1 cm.

14. The locking device according to claim 4, wherein the maximum distance from the operating end to the rotating shaft is more than 5 times the maximum distance from the counterweight part to the rotating shaft.
